(19) United States
(12) Patent Application Publication
(10) Pub. No.: US 2004/0103038 A1
(43) Pub. Date: May 27, 2004

(54) Virtual reality enabled transaction processing system

(76) Inventors: Mark J. Power, Carol Stream, IL (US); Anthony J. Dezonno, Bloomingdale, IL (US); Roger A. Sumner, Batavia, IL (US); Carlo Bonifazi, Woodbridge, IL (US); Jeffrey D. Hodson, Wheaton, IL (US); Craig R. Shambaugh, Wheaton, IL (US); Mark J. Michelson, Elburn, IL (US); Robert P. Beckstrom, Bolingbrook, IL (US)

Correspondence Address: Eric D. Cohen, Welsh & Katz, Ltd., 22nd Floor, 120 South Riverside Plaza, Chicago, IL, 60606, US

(21) Appl. No.: 10/304,873

(22) Filed: Nov. 26, 2002

(51) Int. Cl. G06F 17/60

(52) U.S. Cl. 705/26

(57) ABSTRACT

A transaction processing system includes at least one agent computer, where each agent computer has a processor, an agent display device, and a memory storage subsystem. The processor is operatively coupled to the agent display device and to the memory storage subsystem, and a virtual reality (VR) processor is operatively coupled to the processor. Also included is a VR agent interface configured to provide a common transaction-based VR environment between the agent and the caller to permit a transaction to be initiated and completed in the common VR environment.

### FIELD OF THE INVENTION

The present invention relates generally to apparatus and methods for handling transactions between customers and agents of a transaction processing system and/or an automatic call distribution system (“ACD”), and more specifically to a virtual reality based transaction processing system that permits the customer and the agent to interact in common virtual reality environment and conduct transactions in a common environment.

### BACKGROUND

Systems which automatically distribute customer contacts or calls (generically referred to as “ACD”) are often employed in telemarketing environments in which agents stationed at agent telephone sets answer many different types of telephone calls and other types of customer contacts (e.g., VoIP, emails, facsimile, chat room dialog, instant messages, other Internet contacts, etc.) from customers during a work day. As referred to herein, an ACD may be referred to as an automatic call distributor or an automatic contact distributor because the ACD handles a variety of communication media. In other words, the ACD handles many forms of communication, not just telephone calls in which a potential customer speaks with an agent. The term “ACD” may apply to any type of transaction processing system, and need not apply only to dedicated telemarketing systems or automatic call distributors. In some known ACD's, the agent may receive certain information about the type of customer call (i.e. contact) on a visual display at the agent set when a call or contact is distributed to the agent. An ACD is any such system which performs these functions and, for example, may employ a wide variety of architectures including integrated centralized systems, distributed systems, systems using one or more personal computers or servers, etc.

In some embodiments, ACD's may be used to support a number of different vendors in their telemarketing effort, and in such marketing environments, the agent is typically in communication with the customer or potential customer with respect to or on behalf of a particular vendor. The next contact that the agent processes may be on behalf of the same vendor or on behalf of a different vendor. In another embodiment, ACD's may be used exclusively by or on behalf of a single vendor such that all of the contacts processed by the agent involve one particular vendor.

Often, a customer call is distributed to an agent that involves interactive voice dialog. This means a normal two-way verbal exchange. An ACD, however, may also distribute a non-voice dialog contact or call to the agent. This does not involve direct two-way speech between the agent and the customer or caller. Non-voice dialog communication may be, for example, emails, facsimile, chat room dialog, instant messaging, Internet, etc. and the like. This is becoming more common as Internet traffic and electronic sales transactions increase. Handling of the non-voice dialog contact may in some instances require a specialized device or subcomponent of the ACD. In this situation, the agent may typically view text on a display screen that the caller typed in or transmitted. In response, the agent may provide information to the contact or request information from the caller, via the keyboard or other input device. Essentially, the dialog between the agent and the caller occurs on a display screen. Further, the agent may handle multiple calls. For example, the agent may typically handle two to five (or more) simultaneous non-voice dialog communications or transactions, which may be presented as two to five separate dialog windows on the display screen, which windows may, for example, be tiled or layered. Of course, the number of simultaneous transactions may vary significantly.

Typically, if a voice dialog or voice mode communication is received by the ACD system and routed to the agent, the agent responds verbally and engages in a voice dialog with the caller. Similarly, if a text-base message, such as email or chat, is received by the agent, the agent may typically respond using the same medium, meaning the agent types his or her response and transmits the message it to the caller. Often, during the transaction, either the agent or the customer or potential customer has questions and, hopefully, receives answers to the questions from the other party.

Because the transaction is performed over a geographical distance, that is, the transaction is not a face-to-face meeting, ambiguities and/or misunderstandings may arise. This often occurs if the parties are discussing a complex topic. Moreover, if one party makes reference to a document, a specific place in the document, or a thing, it may be very difficult to communicate one's question to the other party because one party cannot “see” the documents or things that are before the other party. Thus, communication difficulties and errors in understanding or assumptions may arise.

A need exists to permit both parties to a transaction in a transaction processing system to share a common environment, view documents, things, objects, or representations of objects pertinent to the discussion, and interact within the common environment to complete the transaction.

### SUMMARY

The disadvantages of present transaction processing systems may be substantially overcome by a novel apparatus and methods for providing a common VR environment between an agent and a caller. More specifically, one embodiment of a transaction processing system includes at least one agent computer having a processor, an agent display device, and a memory storage subsystem. The processor is operatively coupled to the agent display device and to the memory storage subsystem, and a virtual reality (VR) processor is operatively coupled to the processor. Also included is a VR agent interface configured to provide a common transaction-based VR environment between the agent and the caller to permit a transaction to be initiated and completed in the common VR environment.

### BRIEF DESCRIPTION OF THE DRAWINGS

The features of the present invention which are believed to be novel are set forth with particularity in the appended claims. The invention, together with further objects and advantages thereof, may best be understood by reference to the following description in conjunction with the accompanying drawings.

FIG. 1 is a representation of a specific embodiment of a transaction processing system;

FIG. 2 is a functional block diagram of a specific example of the automatic call distributor system of FIG. 1 shown in greater detail;

FIG. 3 is a functional block diagram of a specific embodiment of an agent computer;

FIG. 4 is a functional block diagram of a specific embodiment of a caller computer; and

FIG. 5 is a specific example of a pictorial representation of an agent display device and a caller display device illustrating examples of graphic and/or three-dimensional images shown to the respective parties.

### DETAILED DESCRIPTION

In this written description, the use of the disjunctive is intended to include the conjunctive. The use of definite or indefinite articles in not intended to indicate cardinality. In particular, a reference to “the” object or thing or “an” object or “a” thing is intended to also describe a plurality of such objects or things.

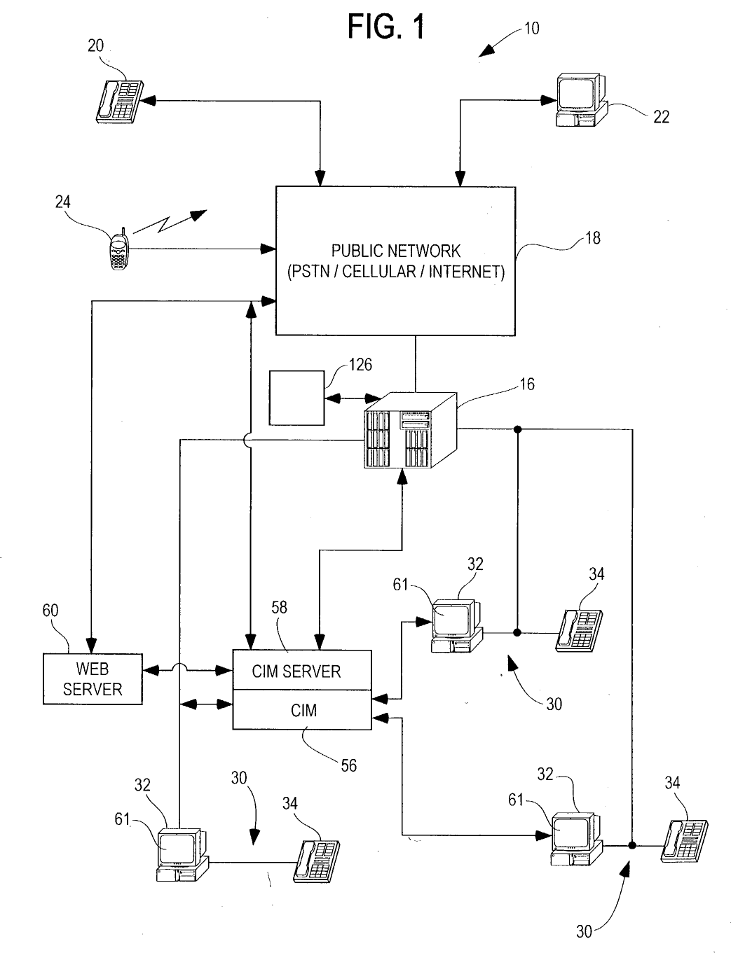

Referring now to FIG. 1, an exemplary embodiment of a system 10 for facilitating routing of incoming calls or contacts (“transactions”) to agents associated with a transaction processing system, which may also be referred to as an automatic call distribution or automatic contact distribution system (ACD) 16, is shown generally. The ACD 16 processes both voice-dialog communications or transactions, as well as non-voice dialog communications and transactions, as described hereinafter. The present invention may be implemented in numerous types and sizes of systems for distributing calls to selected ones of a plurality of agents. Examples of ACD systems that may be used in the present invention are the SPECTRUM ACD and Transcend ACD products available from Rockwell FirstPoint Contact.

Other types of call distribution systems including, for example, distribution systems or those using one or more personal computers or servers, may also be used. Some other suitable ACD's are disclosed in U.S. Pat. No. 5,268,903, issued to Jones et al. on Dec. 7, 1993, entitled “Multichannel Telephonic Switching Network With Different Signaling Formats and Connect/PBX Treatment Selectable For Each Channel,” U.S. Pat. No. 5,140,611, issued to Jones et al. on Aug. 18, 1992, entitled “Pulse width Modulated Self-Clocking and Self-Synchronizing Data Transmission and Method for a Telephonic Communication Switching System,” U.S. Pat. No. 5,127,004, issued to Lenihan et al. on Jun. 30, 1992, entitled “Tone and Announcement Message Code Generator for a Telephonic Switching System and Method,” U.S. Pat. No. 6,289,373 B1, issued to Dezonno on Sep. 11, 2001, entitled “Method of Processing E-Mail in an Automatic Call Distributor,” and U.S. Pat. No. 6,097,806, issued to Baker et al. on Aug. 1, 2000, entitled “ACD with Multi-Lingual Agent Position,” the disclosures of which are hereby incorporated by reference in their entirety.

A customer or caller may be connected to the ACD 16 through a public switched telephone network (PSTN) 18 or other suitable communication network, which caller may connect to the network through a standard telephone set 20, a computer 22, a cellular telephone 24, or any suitable communication device. Note that the term “caller” as used herein does not necessarily mean that the contact or person using the telephone 20, for example, initiated the call to the agent. Notably, the agent or system may have initiated the call to the contact. Accordingly, the term “caller” shall broadly refer to the contact or potential customer even though the agent may have originated or initiated the call or contact. Additionally, the term “call” may be a telephone call, or it may be any other form of communication (e.g. emails etc.) as set forth above.

In the illustrated embodiment, multiple agent stations or terminals 30 are shown coupled to the ACD 16. For purposes of illustration, only three agent stations are shown, but any suitable number of agents may be coupled to the ACD 16. The agent stations 30 may also include agent station computers 32 or terminals, and/or telephone sets 34.

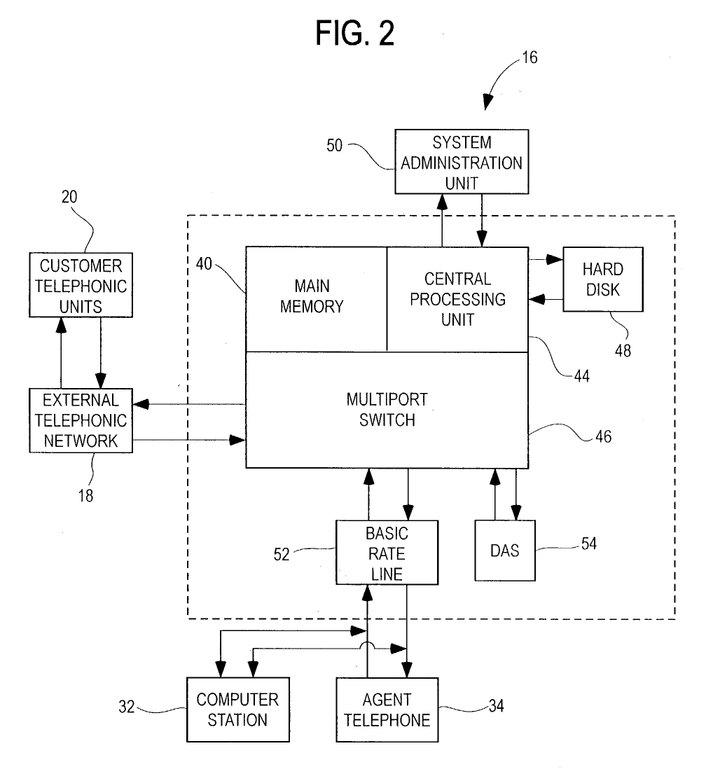

Referring now to FIGS. 1 and 2, FIG. 2 shows an example of an ACD 16 in greater detail. The ACD 16 may comprise hardware and/or software and, for example, may include a main memory 40, a central processing unit 44 and a multiport switch 46, each of which may be separate units, distributed components, or integrated at a single location or single cabinet. The multiport switch 46 is coupled to the PSTN 18, which in turn, is connected to customer telephones 20 or other communication devices, for example, devices 22 or 24. The central processing unit 44 may include storage, such as hard disk storage 48, and may also be coupled to a system administration unit 50. The ACD 16 is connected through a suitable communication link to the plurality of agent telephonic sets 34, for example, through a basic rate line 52, as is known in the art. The agent computer station 32 and the agent telephone sets 34 may be incorporated into a single unit, as is known in the art.

The illustrated ACD 16 may handle voice communication and may also handle non-voice communication, such as emails, facsimile, chat room dialog, instant messaging, Internet, etc. Non-voice dialog communication is another form of contact communication and the ACD 16, when configured and coupled to appropriate hardware and/or software devices, as described below, is not limited to processing voice-based telephone calls. The ACD 16 may be a single integrated device, or may include distributed hardware and software. In one specific embodiment, the SPECTRUM ACD product available from Rockwell FirstPoint Contact may include a non-voice dialog communication processor, such as a Contact Integration Manager (CIM) 56, which may, for example, be a CIM Release No. 1.1, which is also available from Rockwell FirstPoint Contact. In the specific embodiment shown, the communication processor 56 or CIM (also referred to as non-voice dialog communication processor or communication processor) may handle the non-voice dialog communication between the customer or caller, and the agent.

The communication processor 56 may be operatively coupled to the ACD 16 and to the agent computer 32 or agent stations 30. Typically, the communication processor 56 receives email, chat room dialog, facsimile, instant message, Internet communication, and the like from a communication processor server 58. The communication processor server 58, in turn, may receive additional non-voice dialog contact communication from a web server 60, which may be connected to the PSTN 18 or some other communication network, as is known in the art. In one specific embodiment, the communication processor 56 may be separate from the ACD 16 and operatively coupled to the ACD 16. Alternatively, the communication processor 56 may be integrated into a portion of the ACD 16 or any other processor or processors in the system. In another embodiment, at least a portion of the communication processor 56 functionality may be part of the agent station computer 32, which may be, for example, a personal computer. The communication processor 56 may be any suitable computing device, such as, for example a microprocessor, RISC processor, mainframe computer, work station, single-chip computer, distributed processor, server, controller, micro-controller, discrete logic computer, remote computer, personal computer, internet computer, web computer, and the like.

With respect to the apparatus and method described herein, the term ACD 16 is used interchangeably to mean either the ACD and/or the communication processor 56, or a combination of both. Both terms relate to a “transaction processing system” and because the ACD 16 and the communication processor 56 may be so closely related or the functions so distributed that a meaningful distinction may not be able to be made with respect to which particular component is performing a specific step described. Accordingly, for purposes of illustration only, the below-described method will be described in terms of the ACD 16 performing the step or the communication processor 56 performing the step, even though a separate component or subcomponent, such as the other of above-mentioned components, may actually perform the step or process.

The communication processor 56 in the illustrated embodiment is configured to facilitate sending and receiving non-voice dialog communication between the caller and the agent or agent terminal 30, and to transmit a signal to the ACD 16 indicating that the communication processor received the non-voice dialog communication from the caller. The signal from the communication processor 56 to the ACD 16 creates a “call appearance” so that the ACD is brought into the communication “loop,” and is able to track the contact. The call appearance simulates to the ACD 16 the appearance of a voice-type call, even though a voice-type call is not present. Once the call appearance to the ACD 16 has been made, the ACD can queue and track the non-voice dialog communication to the appropriate agent as if the call were an ordinary interactive voice-dialog call, even though the ACD may not utilize or connect its voice channel to the agent. Rather, the communication processor 56 may handle the non-voice dialog communication and provide the call to the agent, and also inform the ACD 16 regarding the status and initiation of the call.

Accordingly, once the call appearance has been made, the ACD 16 in the illustrated embodiment of FIG. 1 selects a particular agent to receive the non-voice dialog communication from the communication processor 56, and then causes the non-voice dialog communication to be routed to the selected agent. In known automatic call distribution systems, selection of the agent is performed according to any suitable method including known methods, such as the agent's availability, time past since prior contact, number of calls previously processed by the agent, skill or efficiency rating of the agent, and the like.

In known ACD systems, when such a contact is routed to an agent, the system typically notifies the agent that a call has arrived, by means known in the art. For example, a message may appear on the agent station 30 and/or an audible signal may be sent to the agent. If the incoming call is a voice dialog communication, the agent speaks with the caller. If the incoming call is a text-based communication, the agent may communicate with the caller by reading and typing messages on the agent station 30 or agent computer.

The ACD or transaction processing system 16 preferably routes voice dialog communication to a selected agent station 30 for servicing by an associated agent using the agent telephone 34 or headset. In conjunction with the communication processor 56, the transaction processing system 16 may, for example route non-voice dialog or text-based communication to the selected agent station. Again, as set forth above, the communication processor 56 need not be separate or apart from the transaction processing system 16 and may be operatively incorporated into the transaction processing system. In operation, the transaction processing system 16 and/or the communication processor 56 routes incoming calls from the callers to the agents, where the incoming calls may be voice dialog communication or non-voice dialog communication, such as VoIP (voice-over Internet protocol), email, facsimile, chat room dialog, instant messages, and other Internet contacts.

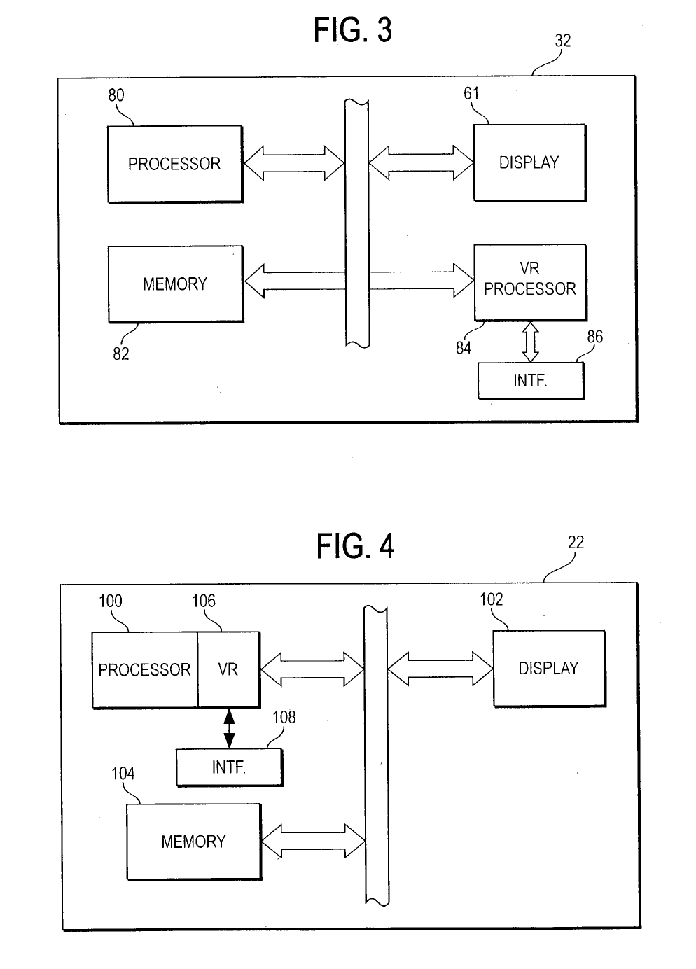

Referring now to FIGS. 3 and 4, FIG. 3 illustrates an example of an agent station computer 32 or terminal in greater detail, while FIG. 4 illustrates an example of a caller computer 22 in greater detail. The agent station computer 32 may include, for example, an agent display device 61, a processor 80, a memory storage subsystem 82, a virtual reality (VR) processor 84, and a VR agent interface 86. Similarly, the caller computer 22 may include many of the same or similar components found in the agent computer 32, such as, for example, a caller processor 100, a caller display 102, a caller memory storage subsystem 104, a caller virtual reality (VR) processor 106, and a VR caller interface 108.

The processor 80 may be any suitable computing device, such as, for example, a microprocessor, RISC processor, mainframe computer, work station, single-chip computer, distributed processor, server, controller, micro-controller, discrete logic computer, remote computer, personal computer, and the like.

The memory storage subsystem 82, may include, for example, mass storage devices, electronically programmable storage, ROM memory, PROM memory, EPROM memory, EEPROM memory, EARPROM memory, RAM, flash memory, optical memory, static memory, bubble memory hard disk memory, and the like, as is know in the art. Any suitable memory devices may be used.

The agent display device 61 may be any suitable display, such as, for example, a touch-screen display, monitor, television screen, CRT display, LCD display, LED display, holographic display, video display, electro-luminescent display, plasma display, and the like, as is known in the art.

The VR processor 84 may be the same type of processor as the processor 80, or may be different therefrom. Alternatively, the VR processor 84 may be a software application run by the processor 80 in the agent station computer 32, and need not be a separate hardware device. It is immaterial to the scope of this invention whether the VR processor 84 is a physical hardware processor or its function is subsumed in a software application. In either implementation, the VR processor 84 may be operatively coupled (either through hardware connections or though logical connections) to the processor 80 and communicates therewith. The VR processor 84 provides and/or is operatively coupled to the VR agent interface 86. The output of the VR agent interface 86 may, for example, be viewed by the agent on his or her agent display device 61. The processor 84 may be operatively coupled to the VR processor 84 and to the agent display device 61. All of the components may be operatively coupled to each other.

Also, the components of the agent computer 32 may be analogous to or may be the same as the components of the caller computer 22. For example, the caller processor 100 may be one of the processors mentioned above. Similar delineation of the components of the caller computer 22 are applicable. Preferably, the caller computer 22 is a personal computer.

In one embodiment, for example, a commercially available software program entitled “Community Server 2.0” from Black Sun Interactive may provide a suitable tool from which to build or “grow” the VR agent interface 86 and/or provide the functions of the VR processor 84. Another such suitable tool is Java 3D™ API (Java 3D) technology commerically available from Sun Microsystems. Such tools are based on a descriptive markup language known as “Virtual Reality Markup Language” (VRML). The VRML language provides a description for creating three dimensional representations of an object on a computer display. The VRML software application may also function as the VR agent interface 86. The terms “VR agent interface” and “VRML” may used interchangeably herein. The VR agent interface 86 provides for interoperability between platforms, such as between the agent computer 32 and the caller computer 22.

In the illustrated embodiment, the VR processor 84 and VR agent interface 86 may provide the agent with a VR environment, while the caller VR processor 106 and the VR caller interface 108 may provide the caller with an identical VR environment. Together, both “halves” may interact to provide a seamless common VR environment to both parties simultaneously. In particular, the VR caller interface 108 of the caller computer 22 may be a counterpart of, and may communicate with the VR agent interface 86 of the agent computer 32. Preferably, the VR agent interface 86 and the VR caller interface 108 are compatible and complement each other's functions.

With respect to VR environments in general, VR is known in various video games and in arcade equipment. VR modeling languages also exist. VR produces an artificial environment that mimics reality. However, known VR environments cannot, and do not provide a simultaneous common environment to both a caller and agent of a transaction processing system that permits a transaction to be started, engaged in, and completed. The present invention permits the caller and the agent to share a common environment that permits such transactions.

Referring now to FIGS. 1, and 3-4, in operation, the agent and the caller communicate with each other through their respective computers 32, 22. In one embodiment, upon establishing a connection, their respective VR interfaces 86, 108 may establish communication. One purpose in some embodiments of providing a common VR environment is to simplify a transaction, and to permit the agent to easily explain, show, and demonstrate various things to the caller that may be pertinent to the transaction. The common VR environment may permit the caller to do likewise.

Known transactions may be subject to ambiguity and misunderstandings that may arise because such known transactions are conducted at a distance, either via a telephone using voice dialog, or via a computer or terminal where each party types in information. It can be easily understood that a complex transaction, such as for example, a house purchase or closing, would be difficult to conduct in this manner because there are so many documents to read and understand. Of course, it is much easier to handle this type of transaction in a face-to-face meeting with all parties present. The present invention may simulate this face-to-face style with its associated advantages.

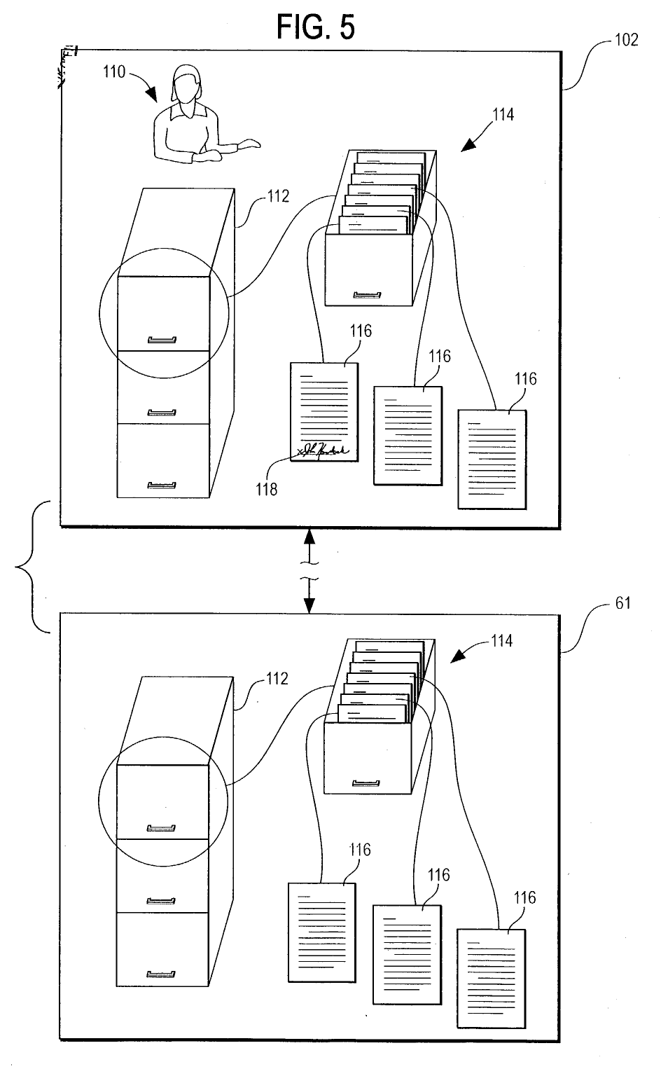

Referring now to FIGS. 1, and 3-5, FIG. 5 illustrates what may be simultaneously shown to the agent and the caller on their respective display devices 61, 102. The above-mentioned house purchase or closing may be the subject of the example transaction in the description below. The illustrated transaction processing system permits such a complex transaction to be handled without the face-to-face scenario. For example, when the VR connection is established between the agent and the caller, the respective VR interfaces 84, 108 may facilitate the display of a representation of the agent 110 (FIG. 5) on the callers display device 102. This may be, for example, a photograph of the agent or an animated form. This may be done to put the caller more at ease and to more closely simulate a face-to-face meeting.

The agent display device 61 may also display a representation of the caller to the agent. Next, the agent may select the documents and things to “show” the caller. These documents and things may, for example, be pre-selected or grouped together by the agent, or may be selected as the transaction progresses. The selected documents may then be placed into a graphic representation of a document organizer. For example, a representation of a filing cabinet 112 may appear on both the agent display screen 61 and the caller display screen 102. The document organizer may be displayed in any suitable form, such as, for example, a filing cabinet, book shelf, book, folder, envelope, desk, enclosure having drawers, ordered list, tree diagram, office furniture, and the like. Note that although the image of the filing cabinet 112 is merely a graphical representation, it indeed contains and permits true access to the documents contained therein. For example, the agent may view an index or table of contents, which may be shown in the form of overlaid front pages of the selected documents 114. To discuss one or more selected documents, the agent may click on those documents, and each selected document 116 would then be expanded to show a portion thereof to both the agent and the caller simultaneously. Preferably, the images shown to both party are realistic three-dimensional images, where applicable.

Three-dimensional virtual images are advantageous because such images present a more familiar and “friendly” interface to the customer. Many customers may be “worried” or ill at ease with respect to reviewing, reading, filling out complex forms and entering required data into dialog boxes on a screen, which is often done in known systems, and without significant guidance. The present invention is advantageous because the customer is put at ease and is made more comfortable because the common VR environment is similar to being at a face-to-face meeting between the buyer and seller. In the common VR environment, each party may have all of the needed documents and things before them, which documents and things may be “spread out” on the respective display devices 61, 102. Accordingly, there may be higher customer acceptability of the transaction, which translates into greater sales or more purchases by the customer.

Returning now to the example of the house purchase or closing, as the transaction progresses, the agent may wish to bring the caller's attention to a particular portion or clause in the documents. The agent may then click or drag that specific portion of the document to a different part of the screen. The agent may then see the graphical image of the agent “grab” that portion of the document and place it conveniently on the caller display device 102 for easy viewing. As another example, the caller may be reading an entire page of a document and may have a question. The caller could simply point to the document clause in question and that portion would automatically be flag or highlighted for the agent to see. The agent, now knowing where to look, can answer the caller's question.

Of course, this functions equally well in either direction because a common VR environment is provided where both the agent and the caller are presented with the documents and/or things on their respective display devices 61, 102 simultaneously and in real time. This essentially simulates a face-to-face meeting where either party can pick up, point to, and generally show where on a document or thing the other party should focus his or her attention. Accordingly, instructions can be given to the other party that are easy to understand, and questions and answers can be posed and resolved, respectively, as if a face-to-face meeting were in progress.

In the above-described example transaction, if the caller wishes to finalize the transaction, the caller may, for example, enter a digital signature 118 at the required places on the documents. Digital signatures or digital certificates are known and may provide a secure means in which to conduct such business. After execution of the appropriate documents, the caller may then provide payment for the house purchased.

With respect to payment, any suitable form of payment may be used. For example, if permitted in this type of large transaction, a credit card may be used. Alternately, the caller's financial institution may be contacted and the caller's account may be debited directly. In one embodiment, while the transaction is ongoing, the purchase price of the house may not yet be fixed. Accordingly, the negotiated price may be changing. To assist the caller in determining whether he or she can afford the transaction, a real time or pseudo-real-time display of the caller's financial accounts may be displayed. Thus, the caller may directly view his accounts on the same screen that shows the various documents and things.

The caller's financial data may also show, for example, the instantaneous value of the caller's stock portfolio. Because stock prices fluctuate through out the day, the caller's “bottom line” may be changing. Thus, the caller can view his or her net worth to determine during the transaction whether he or she can afford to purchase the house. If the caller decides to purchase the house, the caller's account can be debited and the transaction consummated. Similarly, certain stocks or other equities in the caller's portfolio may be liquidated to pay for the transaction. Real time display of the caller's financial accounts also may prevent overdrawing such financial accounts by alerting the caller as to his or her minimum balance.

Note, however, that although the illustrated transaction processing system may provide simultaneous images to the caller and the agent, the caller may decided not to have such financial information shown to the agent for strategic, personal and/or privacy reasons. Thus, in some embodiments, each party may have control over the type of information shown to the other party. Accordingly, the agent may wish to disable the presentation of certain selected information to the caller, such as, for example, the purchase history of the caller and whether the caller is considered to be a good or bad customer.

Of course, all embodiments are not limited to the simultaneous display of documents. In another embodiment, for example, a caller may desire to purchase an automobile. The agent may therefore be presenting various vehicles for sale. In this transaction, an image of the various cars may be displayed to the caller. The caller can then select the car in which he or she is interested and may choose to view more detail. Accordingly, the caller may “zoom” in on a particular portion of the car, and greater detail may be shown to the user. Perhaps the caller has a specific question about the engine of the car. The caller may then click on an image that causes the hood to lift and the engine compartment to be displayed. Further, the caller may have a specific question about one particular component shown. The caller need only point to the specific component in question and the agent will immediately see to what component the caller is pointing. The caller's and the agent's actions may be simultaneously shown to the other party. The agent can then answer the caller's question.

It may be appreciated that the above-described scenarios may be very difficult to transact without the aid of the present common VR environment. For example, if the caller was talking to the agent via telephone and was perhaps holding a catalog of automobiles in his or her hands, the caller could experience significant difficulty in explaining his question about the engine component to the agent. Most likely, the parties would become frustrated and valuable time may be wasted.

Specific embodiments of a VR enabled transaction processing system according to the present invention have been described for the purpose of illustrating the manner in which the invention may be made and used. It should be understood that implementation of other variations and modifications of the invention and its various aspects will be apparent to those skilled in the art, and that the invention is not limited by the specific embodiments described. It is therefore contemplated to cover by the present invention any and all modifications, variations, or equivalents that fall within the true spirit and scope of the basic underlying principles disclosed and claimed herein.

What is claimed is:

1. A transaction processing system configured to route callers to an associated agent, the system comprising:
at least one agent computer having a processor, an agent display device, and a memory storage subsystem, the processor operatively coupled to the agent display device and to the memory storage subsystem;
a virtual reality (VR) processor operatively coupled to the processor; and
VR agent interface configured to provide a common transaction-based VR environment between the agent and the caller to permit a transaction to be initiated and completed in the common VR environment.

2. The system according to claim 1 wherein the caller accesses a caller computer, the caller computer further including a caller display device and a VR caller interface.

3. The system according to claim 2 wherein the VR caller interface facilitates the display of a representation of the agent on the caller display screen.

4. The system according to claim 2 wherein the VR agent interface provides the agent with at least one representation of document organizer, the document organizer providing access to a plurality of documents, the VR caller interface configured to present the document organizer to the caller.

5. The system according to claim 4 wherein the caller display screen provides the caller with instructions and facilitates presentation to the caller of documents in the document organizer.

6. The system according to claim 4 wherein the representation of the document organizer is selected from the group consisting of a filing cabinet, book shelf, desk, enclosure having drawers, ordered list, tree diagram, and office furniture.

7. The system according to claim 2 wherein the VR agent interface provides the agent with at least one representation of a product organizer, the product organizer providing access to a plurality of products, the VR caller interface configured to present the document organizer to the caller.

8. The system according to claim 1 wherein the VR environment provided to the agent is substantially identical to the VR environment provided to the caller.

9. The system according to claim 2 wherein the VR agent interface communicates with the VR caller interface to provide the common transaction-based VR environment such that documents selected by the agent are simultaneously presented to the caller, and documents selected by the caller are simultaneously presented to the agent.

10. The system according to claim 1 wherein at least one representation of document organizer is presented to the agent and to the caller, the document organizer providing access to a plurality of documents.

11. The system according to claim 10 wherein documents selected by the agent are simultaneously presented to the caller, and documents selected by the caller are simultaneously presented to the agent.

12. The system according to claim 11 wherein the agent points out specific portions of the selected documents shown on the agent display device, the specific portions of the documents being presented to the caller on a caller display device.

13. The system according to claim 1 wherein the caller selects products or services to purchase and the transaction is completed.

14. The system according to claim 13 wherein completion of the transaction results in automatically accessing one or more financial accounts of the caller to provide for payment of the transaction.

15. The system according to claim 14 wherein the caller is presented with a real-time representation of the financial accounts to determine if sufficient funds exist in the account to pay for the transaction.

16. The system according to claim 14 wherein the caller disables presentation of the financial accounts to the agent.

17. The system according to claim 14 wherein the caller disables presentation of selected information to the agent and the agent disables presentation of selected information to the agent.

18. A method for providing a common environment to agents of a transaction processing system and callers routed to the agent, the method comprising:
running a VR (virtual reality) software application on an agent computer, the computer having a station processor, an agent display device, and a memory storage subsystem;
operatively coupling the station processor to the agent display device and to the memory storage subsystem;
operatively coupling a virtual reality (VR) processor to the station processor; and
displaying a common VR environment to the agent and the caller to permit a transaction to be initiated and completed in the common VR environment.

19. A transaction processing system configured to route callers to an associated agent, the system comprising:
at least one agent computer having means for processing, means for displaying, and means for storing the means for processors operatively coupled to the means for displaying and to the means for storing;
means for generating a virtual reality environment operatively coupled to the means for processing; and
means for providing VR agent interface configured to provide a common transaction-based VR environment between the agent and the caller to permit a transaction to be initiated and completed in the common VR environment.

20. The system according to claim 19 wherein the caller accesses a caller computer, the caller computer further including a caller display device and a VR caller interface.

21. The system according to claim 20 wherein the VR agent interface provides the agent with at least one representation of document organizer, the document organizer providing access to a plurality of documents, the VR caller interface configured to present the document organizer to the caller.

22. The system according to claim 21 wherein the representation of the document organizer is selected from the group consisting of a filing cabinet, book shelf, desk, enclosure having drawers, ordered list, tree diagram, and office furniture.

23. The system according to claim 20 wherein the VR agent interface communicates with the VR caller interface to provide the common transaction-based VR environment such that documents selected by the agent are simultaneously presented to the caller, and documents selected by the caller are simultaneously presented to the agent.

24. The system according to claim 19 wherein the caller selects products or services to purchase and the transaction is completed.

25. The system according to claim 24 wherein completion of the transaction results in automatically accessing one or more financial accounts of the caller to provide for payment of the transaction.
